(19) United States
(12) Patent Application Publication
(10) Pub. No.: US 2009/0072938 A1
(43) Pub. Date: Mar. 19, 2009

(54) R-T-B SYSTEM ALLOY AND METHOD OF PREPARING R-T-B SYSTEM ALLOY, FINE POWDER FOR R-T-B SYSTEM RARE EARTH PERMANENT MAGNET, AND R-T-B SYSTEM RARE EARTH PERMANENT MAGNET

(75) Inventors: Kenichiro Nakajima, Chichibu-shi (JP); Hiroshi Hasegawa, Chichibu-shi (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Minato-ku, Tokyo (JP)

(21) Appl. No.: 12/299,263

(22) PCT Filed: Feb. 21, 2008
(86) PCT No.: PCT/JP2008/052950

§ 371 Date: Oct. 31, 2008

(30) Foreign Application Priority Data
Mar. 22, 2007 (JP) 2007-075050

(51) Int. Cl. H01F 7/02; B22F 9/08

(52) U.S. Cl. 335/302; 75/331

(57) ABSTRACT

The present invention provides an R-T-B system alloy used as a raw material for a rare earth permanent magnet (wherein R represents at least one selected from the group consisting of Sc, Y, La, Ce, Pr, Nd, Pm, Sm, Eu, Gd, Tb, Ho, Er, Tm, Yb and Lu, T represents a transition metal comprising 80% or more by weight of Fe, and B represents a component comprising 50% or more by weight of B and between 0 to less than 50% by weight of at least one selected from the group consisting of C and N), wherein the content of Mn in the alloy is 0.05% or less by weight.

### TECHNICAL FIELD

The present invention relates to an R-T-B system alloy and a method of preparing an R-T-B system alloy, a fine powder for an R-T-B system rare earth permanent magnet, an R-T-B system rare earth permanent magnet, and more particularly to an R-T-B system alloy from which an R-T-B system rare earth permanent magnet having an excellent coercive force can be obtained, and a fine powder for the R-T-B system rare earth permanent magnet.

This application claims priority on Japanese Patent Application No. 2007-075050 filed on Mar. 22, 2007, the disclosure of which is incorporated by reference herein.

### BACKGROUND ART

An R-T-B system magnet is used for HD (hard disks), MRI (magnetic resonance imaging), and various motors because of its high characteristics. The proportion of applications for motors including automobiles has recently increased due to enhanced requirements for energy saving, in addition to improvements in heat resistance of an R-T-B system magnet. The R-T-B system magnet is generically named an Nd—Fe—B or R-T-B system magnet since it contains Nd, Fe, and B as main components. R of the R-T-B system magnet is that obtained by substituting a portion of Nd with another rare earth element such as Pr, Dy, or Tb. T is that obtained by substituting a portion of Fe with another transition metal such as Co or Ni. B is boron and a portion thereof can be substituted with C or N.

The R-T-B system alloy constituting an R-T-B system magnet is an alloy in which a main phase comprising an R₂T₁₄B phase as a magnetic phase which contributes to a magnetization effect, and a non-magnetic R-rich phase having a low melting point and comprising a concentrated rare earth element coexist. The R-T-B system alloy is an active metal and is therefore usually melted or cast in a vacuum or an inert gas. In order to produce a sintered magnet from a cast R-T-B system alloy ingot by a powder metallurgy process, an alloy ingot is usually ground into an alloy powder having an average grain size of about 5 μm (d50: measured by a laser diffraction type particle size distribution analyzer), press-molded in a magnetic field, sintered in a sintering furnace at a high temperature of about 1,000 to 1,100° C., optionally heat-treated, machined and then plated so as to improve corrosion resistance to obtain a sintered magnet.

In the R-T-B system sintered magnet, the R-rich phase provides the following important roles.

(1) The R-rich phase has a low melting point and is converted into a liquid phase upon sintering, thus contributing to higher density of a magnet, which leads to an improvement in magnetization.
(2) The R-rich phase eliminates irregularity of a grain boundary thereby decreasing a new creation site of a reverse magnetic domain and enhancing a coercive force.
(3) The R-rich phase makes the main phase magnetically insulated thereby increasing a coercive force.

Therefore, insufficient dispersion of the R-rich phase in a formed magnet may cause localized poor sintering and deterioration of magnetism. Therefore, it is important that the R-rich phase be uniformly dispersed in the formed magnet. Distribution of the R-rich phase of the R-T-B system sintered magnet is largely influenced by the structure of an R-T-B system alloy as a raw material.

The problem arising in casting of the R-T-B system alloy includes formation of α-Fe in a cast alloy. α-Fe has deformability and remains in a grinder without being ground. Therefore, α-Fe not only decreases grinding efficiency in the case of grinding the alloy, but also exerts an influence on variation in composition and particle size distribution before and after grinding. Furthermore, α-Fe remaining in the magnet after sintering causes deterioration of magnetic characteristics of the magnet. Therefore, α-Fe has hitherto been removed by subjecting it to a homogenizing treatment at high temperature over a long time, if necessary. However, since α-Fe exists as a peritectic nucleus, solid phase diffusion over a long time is required for removal of α-Fe. It was substantially impossible in an ingot having a thickness of several centimeters and a rare earth content of 33% or less to remove α-Fe.

In order to solve such a problem that α-Fe is produced in the R-T-B system alloy, a strip casting process (hereinafter abbreviated to a “SC process”) of casting an alloy ingot at a higher cooling rate has been developed and put into practical use. The SC process is a process in which a flake having a thickness of about 0.1 to 1 mm is cast by allowing a molten metal to flow on a copper roller water-cooled inside, thereby quench-solidifying the alloy. In the process, since the molten metal is supercooled to a temperature at which an R₂T₁₄B phase as a main phase is produced or lower, the R₂T₁₄B phase can be directly produced from the molten alloy and formation of α-Fe can be suppressed. Since the SC process enables refinement of a crystal structure of the alloy, it becomes possible to prepare an alloy having a structure containing an R-rich phase dispersed finely therein.

The R-rich phase is expanded and converted into a brittle hydride when reacted in a hydrogen atmosphere. When an alloy is subjected to a hydrogenation step, fine cracks corresponding to the dispersion degree of the R-rich phase are introduced into the alloy because of a property of the R-rich phase. When the alloy obtained through the hydrogenation step is finely ground, since the alloy is fractured by numerous fine cracks produced in the hydrogenation step, grindability is remarkably improved. It is known that, since the alloy cast by the SC process contains the R-rich phase dispersed finely therein, dispersibility of the R-rich phase of a magnet after grinding and sintering is improved and thus the resulting magnet is excellent in magnetic characteristics (see, for example, Japanese Unexamined Patent Application, First Publication No. 2006-210377).

An alloy flake cast by the SC process is excellent in homogeneity of the structure. Homogeneity of the structure can be compared by a grain size or a dispersion state of the R-rich phase. In the alloy flake produced by the SC process, while a chill crystal may be generated at the side of a casting roller (hereinafter referred to as a mold surface side), a suitably fine and homogeneous structure formed by quench solidification can be reliably obtained.

As described above, the R-T-B system alloy cast by the SC process has an excellent structure suited for the production of a sintered magnet since the R-rich phase is finely dispersed and the formation of α-Fe is suppressed.

It is also known that magnet characteristics are influenced by the content of trace elements, in addition to uniformity of the structure. It has previously been reported that low-mass elements such as P, S, and O exert an influence on magnetic characteristics, particularly a coercive force (see, for example, Japanese Unexamined Patent Application, First Publication No. 2006-210377, Japanese Unexamined Patent Application, First Publication No. Hei 7-183149). It is also reported that a coercive force is improved by the addition of Ni under certain conditions (see, for example, Japanese Unexamined Patent Application, First Publication No. 2007-049010). As an example of fundamental research, an example of melt-spun for a bond magnet alloy is reported with respect to a relationship between Mn and the magnet (see, for example, G. Xie et al., Mater. Res. Bul., 42 (2007) 131-136). Mn is added to an alloy in the amount of more than 0.05 atomic % for the purpose of improving a coercive force (Japanese Unexamined Patent Application, First Publication No. Hei 1-220803).

Similarly, when the content of Si is more than a certain amount, an adverse influence may be exerted on characteristics as a result of variation in the melting point.

Since magnet characteristics have a fixed relationship with a method of preparing an alloy, the method of preparing an alloy has allowed progress in improving the characteristics of the magnet. For example, a method of controlling a fine structure (see, for example, WO2005/031023) and a method of controlling a fine structure by working a surface of a casting roll so as to provide predetermined roughness (see, for example, Japanese Unexamined Patent Application, First Publication No. 2003-188006, Japanese Unexamined Patent Application, First Publication No. 2004-43291) are known.

### DISCLOSURE OF THE INVENTION

However, an R-T-B system rare earth permanent magnet with higher performance has recently been required and an improvement in magnetic characteristics such as a coercive force of the R-T-B system rare earth permanent magnet is required.

Under these circumstances, the present invention has been made and an object thereof is to provide an R-T-B system alloy which can be used as a raw material of an R-T-B system rare earth permanent magnet having excellent squareness and an excellent coercive force, and a method of preparing an R-T-B system alloy.

Another object of the present invention is to provide a fine powder for an R-T-B system rare earth permanent magnet and an R-T-B system rare earth permanent magnet made from the above R-T-B system alloy.

The present inventors have studied about the relationship between the R-T-B system alloy constituting an R-T-B system rare earth permanent magnet and the magnetic characteristics of a rare earth permanent magnet made therefrom. As a result, the present inventors have found that deterioration of characteristics is caused by excess addition of Mn in an R-T-B system alloy and a rare earth permanent magnet on the contrary. The present inventors have studied furthermore and confirmed that, by adjusting the content of Mn in the R-T-B system alloy to 0.05% or less by weight, an R-T-B system rare earth permanent magnet which is obtained by molding and sintering fine powders prepared from the R-T-B system alloy is excellent in squareness and coercive force, and thus the present invention has been completed.

That is, the present invention provides the following aspects:

(1) An R-T-B system alloy used as a raw material for a rare earth permanent magnet (wherein R represents at least one selected from the group consisting of Sc, Y, La, Ce, Pr, Nd, Pm, Sm, Eu, Gd, Tb, Ho, Er, Tm, Yb and Lu, T represents a transition metal comprising 80% or more by weight of Fe, and B represents a component comprising 50% or more by weight of B and between 0 to less than 50% by weight of at least one selected from the group consisting of C and N), wherein the content of Mn in the alloy is 0.05% or less by weight.
(2) The R-T-B system alloy according to (1), which is in the form of a flake having an average thickness of 0.1 to 1 mm produced by a strip casting process.
(3) A method of preparing the R-T-B system alloy R-T-B system alloy according to (1) or (2), which comprises: forming a flake having an average thickness of 0.1 to 1 mm by a strip casting process and adjusting an average feed rate of molten metal to a chill roll to at least 10 g/sec per width of 1 cm.
(4) A fine powder for an R-T-B system rare earth permanent magnet made from the R-T-B system alloy according to (1) or (2), or an R-T-B system alloy prepared by the method of preparing an R-T-B system alloy according to (3).
(5) An R-T-B system rare earth permanent magnet made from the fine powder for an R-T-B system rare earth permanent magnet according to (4).

Since the content of Mn, as an element exerting an adverse influence on magnet characteristics, in the R-T-B system alloy of the present invention is 0.05% or less by weight, an R-T-B system rare earth permanent magnet having high squareness and a high coercive force as well as excellent magnetic characteristics can be realized.

The fine powder for the R-T-B system rare earth permanent magnet and the R-T-B system rare earth permanent magnet of the present invention are produced from the R-T-B system alloy of the present invention or the R-T-B system alloy prepared by the method of preparing an R-T-B system alloy of the present invention and therefore have high squareness and a high coercive force as well as excellent magnetic characteristics.

### BRIEF DESCRIPTION OF THE DRAWINGS

FIG. 1, which is a photograph showing an example of an R-T-B system alloy of the present invention, is a backscattered electron image when a cross-section of a flake of the R-T-B system alloy is observed by a scanning electron microscope (SEM).

FIG. 2(a) is a graph showing the X-ray image using a wavelength dispersive X-ray spectrometer of EPMA of the R-T-B system alloy shown in FIG. 1, and FIG. 2(b) is a backscattered electron image of the R-T-B system alloy in the area of FIG. 2(a) subjected to X-ray image.

FIG. 3 is a schematic view of a casting device of a strip casting process.

FIG. 4 is a graph showing a relationship between the content of Mn in an R-T-B system alloy, and the squareness of an R-T-B system rare earth permanent magnet made from the R-T-B system alloy.

FIG. 5 is a graph showing a relationship between the content of Mn in an R-T-B system alloy, and the coercive force of an R-T-B system rare earth permanent magnet made from the R-T-B system alloy.

### BRIEF DESCRIPTION OF REFERENCE NUMERALS

1: Refractory crucible
2: Tundish
3 Casting roll
4 Collection container
5 R-T-B system alloy

### BEST MODE FOR CARRYING OUT THE INVENTION

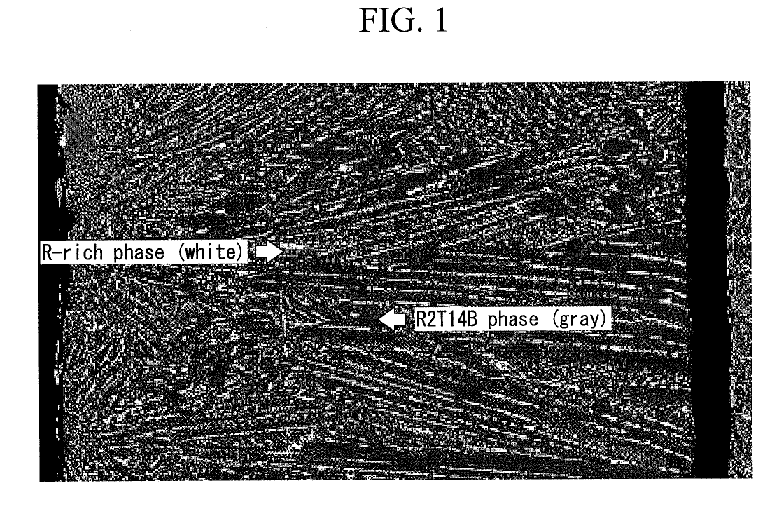

FIG. 1, which is a photograph showing an example of an R-T-B system alloy of the present invention, is a backscattered electron image when a cross-section of a flake of the R-T-B system alloy is observed by a scanning electron microscope (SEM). In FIG. 1, the left side corresponds to a mold surface side.

The R-T-B system alloy shown in FIG. 1 is prepared by an SC process. The R-T-B system alloy has a composition consisting of, in a weight ratio: Nd: 25%, Pr: 6%, B: 1.0%, Co: 0.3%, Al: 0.2%, Si: 0.05%, Mn: 0.03%, and the balance being Fe.

The composition of the R-T-B system alloy of the present invention is not limited to the above range and may be any composition as long as the alloy is an R-T-B system alloy (wherein R represents at least one selected from the group consisting of Sc, Y, La, Ce, Pr, Nd, Pm, Sm, Eu, Gd, Tb, Ho, Er, Tm, Yb and Lu, T represents a transition metal comprising 80% or more by weight of Fe, and B represents a component comprising 50% or more by weight of B and between 0 to less than 50% by weight of at least one selected from the group consisting of C and N), wherein the content of Mn in the alloy is 0.05% or less by weight. The content of Si, as an element exerting an adverse influence on magnet characteristics, is preferably 0.07% or less by weight.

The R-T-B system alloy shown in FIG. 1 is composed of an R₂T₁₄B phase (main phase) and an R-rich phase. In FIG. 1, the R-rich phase is indicated by a white color, whereas, the R₂T₁₄B phase (main phase) is indicated by a dark gray color as compared with the R-rich phase. The R₂T₁₄B phase is mainly composed of a columnar crystal and partially includes an equiaxial crystal. The average grain size in a minor axis of the R₂T₁₄B phase is from 10 to 50 μm. In the grain boundary and grains of the R₂T₁₄B phase, a linear R-rich phase extending along a major axis of the columnar crystal of the R₂T₁₄B phase, or a partially discontinuous or granular R-rich phase exists. The R-rich phase is a non-magnetic phase having a low melting point in which R is concentrated as compared with the composition ratio. The average distance of the R-rich phase is from 3 to 10 μm.

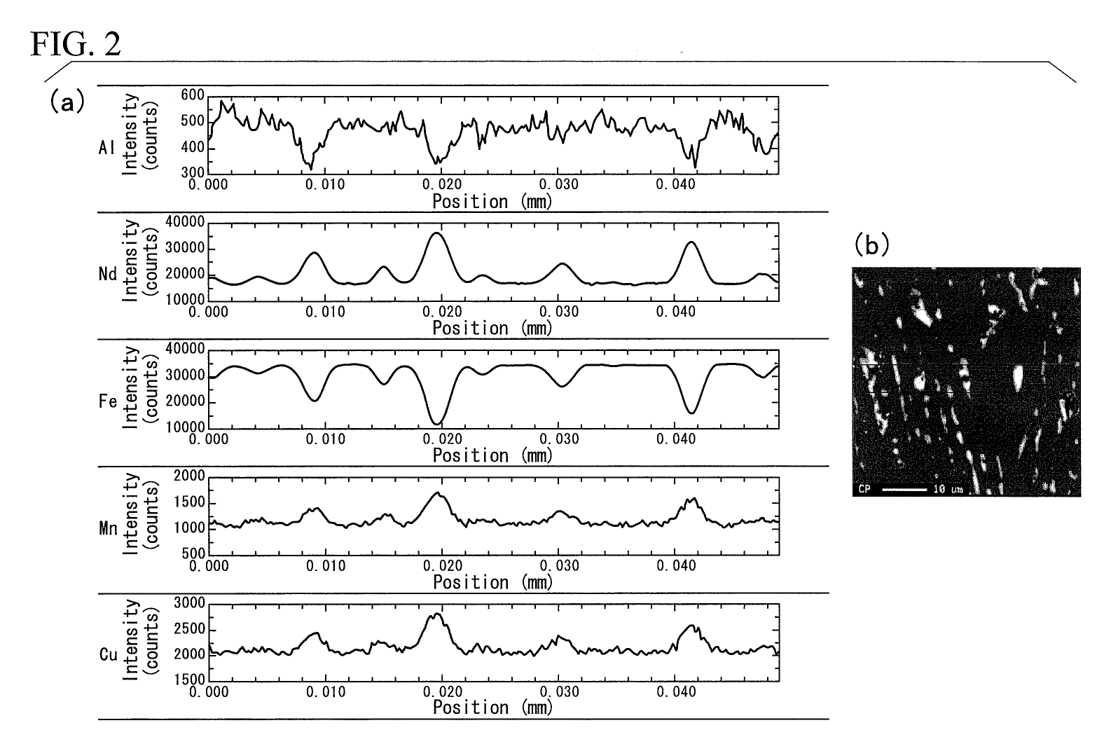

FIG. 2(a) is a graph showing the X-ray image (digital mapping) of Al, Nd, Fe, Mn, and Cu using a wavelength dispersive X-ray spectrometer (WDS) of electron probe micro-analysis (EPMA) of the R-T-B system alloy shown in FIG. 1, and FIG. 2(b) is a backscattered electron image of the R-T-B system alloy in the area of FIG. 2(a) subjected to X-ray image.

As is apparent from the X-ray image shown in FIG. 2(a), the content of Fe and Al in the R₂T₁₄B phase is large. As is apparent from FIG. 2(a), when a forward position of 0 to 0.01 mm as a predetermined position, a position in the vicinity of 0.02 mm and a position in the vicinity of 0.04 mm are compared, the content of Nd, Mn, and Cu is large in the R-rich phase as the area with a small content of Fe and Al.

### (Production of R-T-B System Rare Earth Permanent Magnet)

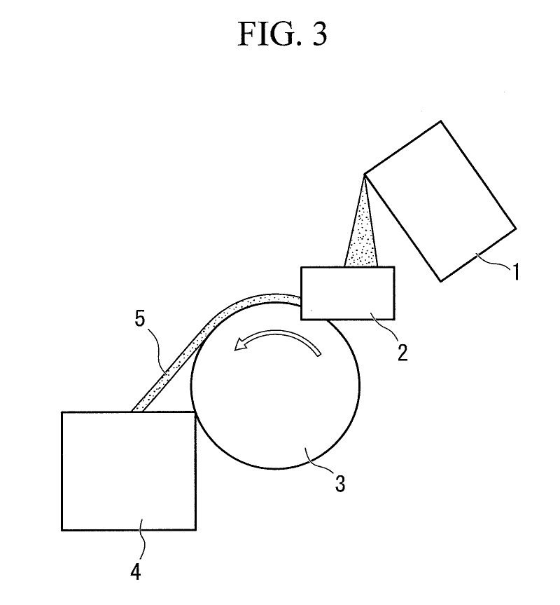

In order to produce an R-T-B system rare earth permanent magnet of the present invention, first, a fine powder for the R-T-B system rare earth permanent magnet is prepared from the R-T-B system alloy of the present invention shown in FIG. 1. The R-T-B system alloy of the present invention is prepared, for example, by an SC process using the casting device shown in FIG. 3.

First, a raw material of an R-T-B system alloy of the present invention is placed in a refractory crucible 1 shown in FIG. 3 and then melted in a vacuum or an inert gas atmosphere to give molten metal. The molten alloy is fed onto a casting roll 3 (chill roll) water-cooled inside at an average feed rate of molten metal of 10 g/sec per width of 1 cm through a tundish 2 equipped with a rectification mechanism or a slag removal mechanism, if necessary, and then solidified on the casting roll 3 to give a flake having an average thickness of 0.1 to 1 mm. The flake of the solidified R-T-B system alloy 5 is detached from the casting roll 3 at the side opposite the tundish 2, collected and recovered in a collection container 4. The structure state of the R-rich phase of the R-T-B system alloy 5 thus obtained can be controlled by suitably adjusting the temperature of the flake of the R-T-B system alloy 5 collected in the collection container 4.

When the average thickness of the flake of the R-T-B system alloy 5 thus obtained is less than 0.1 mm, the solidification rate excessively increases and the R-rich phase is dispersed too finely. In contrast, when the average thickness of the flake of the R-T-B system alloy 5 is more than 1 mm, the solidification rate decreases, thereby causing deterioration of dispersibility of the R-rich phase, formation of α-Fe and coarsening of the R₂T₁₇ phase.

In the above method, the average feed rate of the molten metal to the casting roll 3 can be controlled to at least 10 g/sec per width of 1 cm, preferably to at least 20 g/sec per width of 1 cm, more preferably at least 25 g/sec per width of 1 cm, and still more preferably at most 100 g/sec per width of 1 cm. When the average feed rate of the molten metal to the casting roll 3 is less than 10 g/sec, because of viscosity of the molten metal itself and wettability of the casting roll 3 with the surface, the molten metal does not thinly spread over the casting roll 3 and shrinks, thereby causing variation in quality of the alloy. When the average feed rate of the molten metal to the casting roll is more than 100 g/sec per width of 1 cm, cooling on the casting roll 3 becomes insufficient, thereby causing coarsening of the structure, and thus formation of α-Fe may occur.

Next, a fine powder for an R-T-B system rare earth permanent magnet of the present invention is produced using a flake of the R-T-B system alloy of the present invention thus obtained. First, hydrogen is absorbed to a flake made of the R-T-B system alloy of the present invention at room temperature and hydrogen is removed by dehydration at 500° C. Then, the flake of the R-T-B system alloy is finely ground into a powder for an R-T-B system rare earth permanent magnet having an average particle size d50 of 4 to 5 μm using a grinder such as a jet mill. The resulting fine powder for an R-T-B system rare earth permanent magnet is press-molded using a transverse magnetic field-type molding machine and the resulting molded body is sintered in a vacuum at 1,030 to 1,100° C. to obtain an R-T-B system rare earth permanent magnet.

The R-T-B system rare earth permanent magnet thus obtained is made from an R-T-B system alloy in which the content of Mn as an element exerting an adverse influence on magnet characteristics is 0.05% or less by weight, and therefore has high squareness and a high coercive force as well as magnetic characteristics.

### EXAMPLES

### Content of Mn: 0.02% by Weight

A raw material with a composition consisting of, in a weight ratio: Nd: 25%, Pr: 6%, B: 1.0%, Co: 0.2%, Al: 0.2%, Si: 0.05%, Mn: 0.02%, and the balance being Fe was weighed, placed in a refractory crucible 1 made of alumina of the manufacturing device shown in FIG. 3 and then melted in an atmosphere of 1 atmospheric pressure of an argon gas using a high frequency melting furnace to obtain a molten alloy. The resulting molten alloy was fed onto a casting roll 3 (chill roll) through the tundish 2 and then cast by a SC process to obtain a flake of an R-T-B system alloy.

The average feed rate of the molten metal to the casting roll 3 upon casting was 25 g/second per width of 1 cm and the average thickness of the flake of the resulting R-T-B system alloy was 0.3 mm. The peripheral speed of the casting rotating roller 3 was 1.0 m/s.

Next, a magnet was produced in the following manner using the resulting flake of the R-T-B system alloy. First, the flake of the R-T-B system alloy of the Example was subjected to hydrogen decrepitation. Hydrogen decrepitation was carried out by a method of absorbing hydrogen to the flake of the R-T-B system alloy at room temperature in hydrogen of 2 atmospheric pressure, drawing the remaining hydrogen with heating to 500° C. in a vacuum, adding 0.07% by weight of zinc stearate, and finely grinding the flake using a jet mill of a nitrogen gas flow. The average particle size of the powder obtained by finely grinding as measured by a laser diffraction type process was 5.0 μm.

The resulting fine powder for an R-T-B system rare earth permanent magnet was press-molded under a molding pressure of 0.8 t/cm² in a 100% nitrogen atmosphere using a transverse magnetic field-type molding machine to obtain a molded body. The resulting molded body was heated from room temperature in a vacuum of 1.33×10⁻⁵ hPa and then maintained at 500° C. and 800° C. for one hour thereby removing zinc stearate and residual hydrogen. The molded body was heated to 1,030° C. as a sintering temperature and then maintained at the same temperature for 3 hours to obtain a sintered body. The resulting sintered body was subjected to a heat treatment in an argon atmosphere at 800° C. and 530° C. for one hour to obtain an R-T-B system rare earth permanent magnet in which the content of Mn was 0.02% by weight.

### “Content of Mn: 0.03 to 0.14% by Weight”

In the same manner as in the R-T-B system rare earth permanent magnet in which the content of Mn was 0.02% by weight, except that the content of Mn was adjusted to 0.03 to 0.14% by weight, an R-T-B system rare earth permanent magnet in which the content of Mn was from 0.03 to 0.14% by weight was obtained.

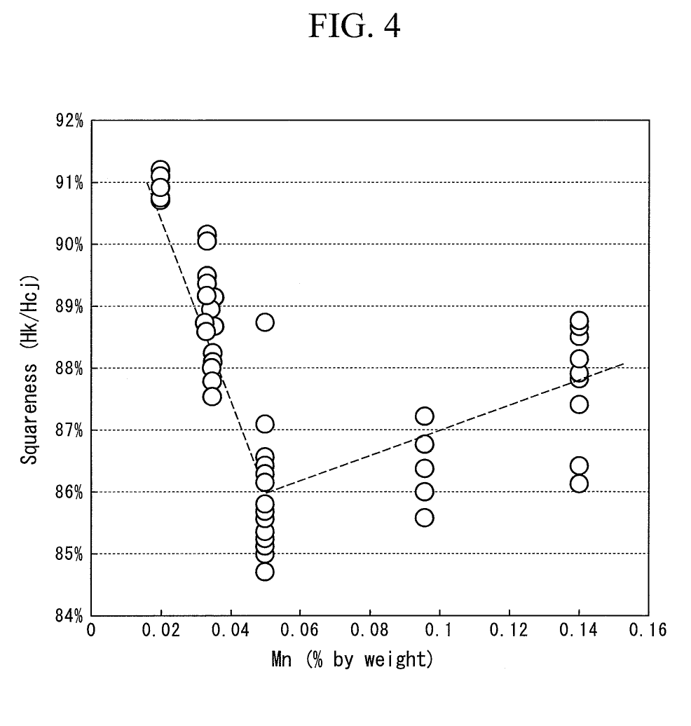

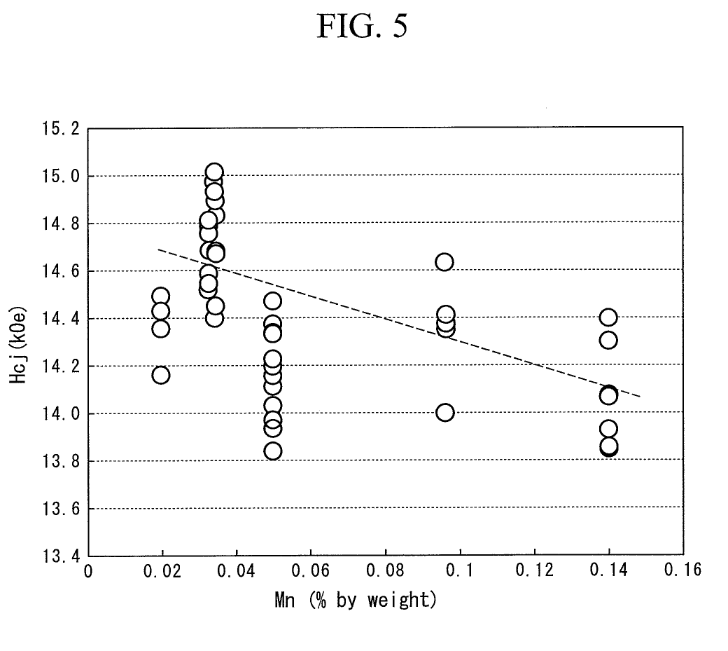

Hk/Hcj (squareness) and Hcj (coercive force) of the resulting R-T-B system rare earth permanent magnets having a different content of Mn were measured by a BH curve tracer. The results are shown in FIG. 4 and FIG. 5.

FIG. 4 is a graph showing a relationship between the content (% by weight) of Mn in an R-T-B system alloy, and the squareness (Hk/Hcj) of an R-T-B system rare earth permanent magnet made from the R-T-B system alloy.

As is apparent from FIG. 4, when the content of Mn in the R-T-B system alloy is within a range from 0.02 to 0.05% by weight, squareness of the R-T-B system rare earth permanent magnet decreases and squareness deteriorates as the content of Mn increases. It was also found that the R-T-B system rare earth permanent magnet showed stable squareness at a low level when the content of Mn in the R-T-B system alloy was more than 0.05% by weight.

FIG. 5 is a graph showing a relationship between the content of Mn in an R-T-B system alloy, and the coercive force (Hcj) of an R-T-B system rare earth permanent magnet made from the R-T-B system alloy. As is apparent from FIG. 5, the coercive force of the R-T-B system rare earth permanent magnet decreases as the content of Mn in the R-T-B system alloy increases. It was found that, when the content of Mn in the R-T-B system alloy was less than 0.05% by weight, a coercive force of 14.3 or more was obtained.

The reason is considered that, as the content of Mn increases, optimum sintering temperature slightly increases and sintering does not sufficiently proceed. It can be concluded that, even considering that Hcj decreases when the sintering temperature increases, the coercive force of the R-T-B system rare earth permanent magnet is preferred as the content of Mn in the R-T-B system alloy is low.

It could be confirmed from FIG. 4 and FIG. 5 that, by adjusting the content of Mn in the R-T-B system alloy to 0.05% or less by weight, an R-T-B system rare earth permanent magnet which is obtained by molding and sintering fine powders prepared from the R-T-B system alloy is excellent in squareness and coercive force.

### INDUSTRIAL APPLICABILITY

Since the content of Mn, as an element exerting an adverse influence on magnet characteristics, in the R-T-B system alloy of the present invention is 0.05% or less by weight, an R-T-B system rare earth permanent magnet having high squareness and a high coercive force as well as excellent magnetic characteristics can be realized.

The fine powder for R-T-B system rare earth permanent magnet and the R-T-B system rare earth permanent magnet of the present invention are produced from the R-T-B system alloy of the present invention or the R-T-B system alloy prepared by the method of preparing an R-T-B system alloy of the present invention and therefore have high squareness and a high coercive force as well as excellent magnetic characteristics.

1. An R-T-B system alloy used as a raw material for a rare earth permanent magnet:
wherein R represents at least one selected from the group consisting of Sc, Y, La, Ce, Pr, Nd, Pm, Sm, Eu, Gd, Tb, Ho, Er, Tm, Yb and Lu, T represents a transition metal comprising 80% or more by weight of Fe, and B represents a component comprising 50% or more by weight of B and between 0 to less than 50% by weight of at least one selected from the group consisting of C and N;
wherein the content of Mn in the alloy is 0.05% or less by weight.

2. The R-T-B system alloy according to claim 1, which is in the form of a flake having an average thickness of 0.1 to 1 mm produced by a strip casting process.

3. A method of preparing the R-T-B system alloy R-T-B system alloy according to claim 1, which comprises:
forming a flake having an average thickness of 0.1 to 1 mm by a strip casting process and adjusting an average feed rate of molten metal to a chill roll to at least 10 g/sec per width of 1 cm.

4. A fine powder for an R-T-B system rare earth permanent magnet made from the R-T-B system alloy according to claim 1.

5. A fine powder for an R-T-B system rare earth permanent magnet made from an R-T-B system alloy prepared by the method of preparing an R-T-B system alloy according to claim 3.

6. An R-T-B system rare earth permanent magnet made from the fine powder for an R-T-B system rare earth permanent magnet according to claim 4.

7. An R-T-B system rare earth permanent magnet made from the fine powder for an R-T-B system rare earth permanent magnet according to claim 5.

8. A method of preparing the R-T-B system alloy R-T-B system alloy according to claim 2, which comprises:
forming a flake having an average thickness of 0.1 to 1 mm by a strip casting process and adjusting an average feed rate of molten metal to a chill roll to at least 10 g/sec per width of 1 cm.

9. A fine powder for an R-T-B system rare earth permanent magnet made from the R-T-B system alloy according to claim 2.

10. A fine powder for an R-T-B system rare earth permanent magnet made from an R-T-B system alloy prepared by the method of preparing an R-T-B system alloy according to claim 8.

11. An R-T-B system rare earth permanent magnet made from the fine powder for an R-T-B system rare earth permanent magnet according to claim 9.

12. An R-T-B system rare earth permanent magnet made from the fine powder for an R-T-B system rare earth permanent magnet according to claim 10.
